(19) United States
(12) Patent Application Publication
(10) Pub. No.: US 2025/0370372 A1
(43) Pub. Date: Dec. 4, 2025

(54) INFORMATION PROCESSING APPARATUS, IMAGE FORMING APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: YASUTOMO FURUTA, Chiba (JP)

(21) Appl. No.: 19/220,550

(22) Filed: May 28, 2025

(30) Foreign Application Priority Data
May 30, 2024 (JP) 2024-088281

(51) Int. Cl. G03G 15/043; B41J 2/447; B41J 2/47; G03G 15/00; G03G 15/04; G06K 15/14

(52) U.S. Cl. CPC G03G 15/043; B41J 2/447; B41J 2/47; G03G 15/04063; G03G 15/5062; G06K 15/14

(57) ABSTRACT

An information processing apparatus that generates correction data for correcting light intensity of an image forming apparatus that includes an exposure head that includes a plurality of light-emitting element array chips that each include a plurality of light-emitting elements, the information processing apparatus comprises a first correction unit configured to generate first correction data for correcting light intensity differences at boundaries between adjacent light-emitting element array chips; and a second correction unit configured to generate second correction data for correcting light intensity distribution of the exposure head corrected using the first correction data.

### BACKGROUND

### Field of the Technology

The present disclosure relates to an information processing apparatus, an image forming apparatus, a control method, and a non-transitory computer-readable storage medium.

### Description of the Related Art

There are known image forming apparatuses that include an exposure head and a photosensitive rod, and print images. The exposure head includes a plurality of light-emitting element array chips that each include a plurality of light-emitting elements. In such image forming apparatuses, the light-emitting elements of the exposure head irradiate the photosensitive rod with light, and thereby an image is printed on a recording medium such as paper.

In such image forming apparatuses, there are differences in light intensity between light-emitting elements, and thus, there are known techniques for correcting light intensity.

For example, Japanese Patent Laid-Open No. 2018-1679 discloses a technique for obtaining and correcting the differences in the average value of light intensity between light-emitting element array chips based on variation in density of a printed chart read by a scanner or the like, and then correcting the light intensity of end portions of the light light-emitting element array chips.

However, with the technique of Japanese Patent Laid-Open No. 2018-1679, light intensity is corrected in a state where there is a sharp difference in light intensity at boundaries between light-emitting element array chips, and thus the accuracy of correction of light intensity has not been sufficient.

### SUMMARY

In view of this, the present disclosure provides an image forming apparatus, and an information processing apparatus, a control method, and a program, which are capable of improving the accuracy of correction of light intensity of the image forming apparatus, and control the image forming apparatus.

According to one aspect of the present disclosure, there is provided an information processing apparatus that generates correction data for correcting light intensity of an image forming apparatus that includes an exposure head that includes a plurality of light-emitting element array chips that each include a plurality of light-emitting elements, the information processing apparatus comprising: a first correction unit configured to generate first correction data for correcting light intensity differences at boundaries between adjacent light-emitting element array chips; and a second correction unit configured to generate second correction data for correcting light intensity distribution of the exposure head corrected using the first correction data.

According to another aspect of the present disclosure, there is provided an image forming apparatus comprising: the information processing apparatus above; the exposure head that is controlled by the information processing apparatus; and a photosensitive drum on which an electrostatic latent image is formed by the exposure head.

According to another aspect of the present disclosure, there is provided a control method for generating correction data for correcting light intensity of an image forming apparatus that includes an exposure head that includes a plurality of light-emitting element array chips that each include a plurality of light-emitting elements, the method comprising: generating first correction data for correcting light intensity differences at boundaries between adjacent light-emitting element array chips; and generating second correction data for correcting light intensity distribution of the exposure head corrected using the first correction data.

According to another aspect of the present disclosure, there is provided a non-transitory computer-readable storage medium storing a computer program that, when read and executed by the computer for generating correction data for correcting light intensity of an image forming apparatus that includes an exposure head that includes a plurality of light-emitting element array chips that each include a plurality of light-emitting elements, causes the computer to function as: a first correction unit configured to generate first correction data for correcting light intensity differences at boundaries between adjacent light-emitting element array chips, and a second correction unit configured to generate second correction data for correcting light intensity distribution of the exposure head corrected using the first correction data.

Further features of the present disclosure will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing an overall configuration of an image forming apparatus according to an embodiment.

FIG. 2A is a diagram illustrating an exposure head and a photosensitive drum according to the embodiment.

FIG. 2B is a diagram illustrating the exposure head and the photosensitive drum according to the embodiment.

FIG. 3A is a plan view of the surface opposite to the surface on which a light-emitting element group according to the embodiment is mounted.

FIG. 3B is a plan view of the surface on which the light-emitting element group is mounted.

FIG. 3C is an enlarged plan view of boundary portions between light-emitting element array chips.

FIG. 4 is a plan view showing a schematic configuration of a light-emitting element array chip according to the embodiment.

FIG. 5 is a cross-sectional view of a portion of a light-emitting portion according to the embodiment.

FIG. 6A is a plan view illustrating arrangement of a plurality of light-emitting elements of the light-emitting portion.

FIG. 6B is a diagram showing light spots of light-emitting element rows when light emission timings of the light-emitting element rows are shifted to expose the same row on the photosensitive drum.

FIG. 7 is a block diagram illustrating a control system of the image forming apparatus according to the embodiment.

FIG. 8 is a block diagram of an internal circuit of a light-emitting element array chip according to an embodiment.

FIG. 9 is a block diagram illustrating a configuration of a light intensity correction unit according to the embodiment.

FIG. 10A is a diagram showing an example of an image before correction.

FIG. 10B is a diagram showing an image for correction.

FIG. 10C is a diagram showing a corrected image.

FIG. 11 is a diagram of a light intensity correction chart that is printed in order to obtain light intensity variation.

FIG. 12 is a diagram of a flowchart of correction processing for generating correction data for correcting light intensity.

FIG. 13 is a diagram of light intensity distribution of the exposure head before correction in a long-side direction of light-emitting element array chips.

FIG. 14 is a diagram of light intensity distribution of the exposure head after correction in a long-side direction of light-emitting element array chips.

FIG. 15 is a diagram of light intensity distribution before correction in light-emitting element array chips.

FIG. 16A is a diagram of two-dimensional image information corresponding to one light-emitting element array chip obtained by a scanner unit.

FIG. 16B is a diagram showing a state where a dot has been unintentionally printed on a light intensity correction chart due to dirt or the like.

FIG. 17 is a diagram showing light intensity distribution of 18 sample area columns corresponding to one light-emitting element array chip.

FIG. 18 is a diagram showing light intensity distribution in a case where vertical streaks have appeared on an image.

FIG. 19A is a plan view showing a state where light-emitting element array chips are arranged.

FIG. 19B is a plan view showing a state where light-emitting element array chips are arranged.

FIG. 20 is a block diagram illustrating a hardware configuration of a control system of an image forming apparatus according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### EMBODIMENT

### Overall Configuration of Image Forming Apparatus

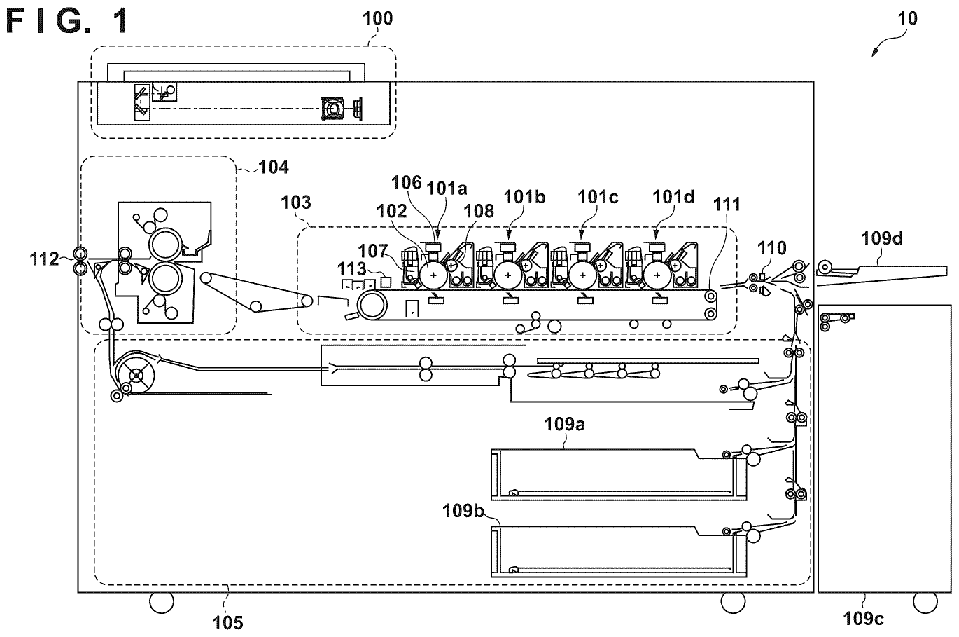

An electrophotographic image forming apparatus 10 according to the present embodiment will be briefly described. FIG. 1 is a diagram showing an overall configuration of the image forming apparatus 10. The image forming apparatus 10 includes a scanner unit 100, an imaging unit 103, a fixing unit 104, a paper feeding/conveyance unit 105, an optical sensor 113, and a printer control unit (not illustrated) for controlling them. In the following description, the term “image” may include “image data”.

The scanner unit 100 irradiates a document placed on a document platen with light, and optically reads an image of the document. The scanner unit 100 converts the light of the read image of the document into electrical signals, and creates and outputs image data.

The imaging unit 103 includes four image forming units 101a, 101b, 101c, and 101d. When there is no need to distinguish the image forming units 101a, 101b, 101c, and 101d from each other, the image forming units 101a, 101b, 101c, and 101d are each referred to as an “image forming unit 101”. The number of image forming units 101 is not limited to four, and may be changed as appropriate. The present embodiment includes the four image forming units 101a, 101b, 101c, and 101d respectively corresponding to four colors, namely, cyan (C), magenta (M), yellow (Y), and black (K). The four image forming units 101 are arranged in the order of cyan (C), magenta (M), yellow (Y), and black (K). The image forming units 101 each perform a series of electrophotographic processes (charging, exposure, development, and transfer) on a recording medium such as paper that is being conveyed. The four image forming units 101 sequentially execute magenta, yellow, and black image forming operations after a predetermined time has elapsed from when a cyan station started imaging. Accordingly, the four image forming units 101 sequentially print images of the corresponding colors to form a full-color image on paper.

Each image forming unit 101 includes a photosensitive drum 102, an exposure head 106, a charging device 107, and a developing device 108. The photosensitive drum 102 is driven to rotate. The charging device 107 electrically charges the photosensitive drum 102 that is being driven to rotate. The exposure head 106 irradiates the photosensitive drum 102 with light to form an electrostatic latent image according to image data. The developing device 108 develops the electrostatic latent image formed on the photosensitive drum 102 using toner, and thereby generates a toner image. The toner image is transferred onto paper that is being conveyed on a transfer belt 111.

The paper feeding/conveyance unit 105 includes an internal paper feeding unit 109a, an internal paper feeding unit 109b, an external paper feeding unit 109c, a manual paper feeding unit 109d, registration rollers 110, and the transfer belt 111. In the paper feeding/conveyance unit 105, paper is fed by a paper feeding unit directed in advance among the internal paper feeding unit 109a, the internal paper feeding unit 109b, the external paper feeding unit 109c, and the manual paper feeding unit 109d. The fed paper is conveyed to the registration rollers 110. The registration rollers 110 convey the paper to the transfer belt 111 at the timing when a toner image formed in the above-described imaging unit 103 is transferred onto the paper. The optical sensor 113 is disposed at a position opposing the transfer belt 111. The optical sensor 113 detects the position of a test chart printed on the transfer belt 111 in order to derive the amount of color misalignment between the stations. The amount of color misalignment derived here is notified to an image controller unit to be described later, and the image positions of the respective colors are corrected. By performing this control, a full-color toner image that has no color misalignment is transferred onto the paper.

The fixing unit 104 includes a plurality of opposing rollers and a heat source such as a halogen heater. In the fixing unit 104, the toner on the paper, the paper having a toner image transferred thereonto and having been conveyed from the transfer belt 111, is dissolved by heat of the heat source and pressure of the rollers, and is fixed to the paper. The fixing unit 104 discharges the paper to which the toner image has been fixed, to the outside of the image forming apparatus 10 using paper discharge rollers 112.

The printer control unit (not illustrated) communicates with an overall control unit (not illustrated) that performs overall control of the image forming apparatus 10), to execute control of image formation in accordance with an instruction from the overall control unit, and perform control such that the entire apparatus can operate smoothly in harmony while managing the statuses of the aforementioned scanner unit, imaging unit, fixing unit, and paper feeding/conveyance unit.

### Configuration of Exposure Head

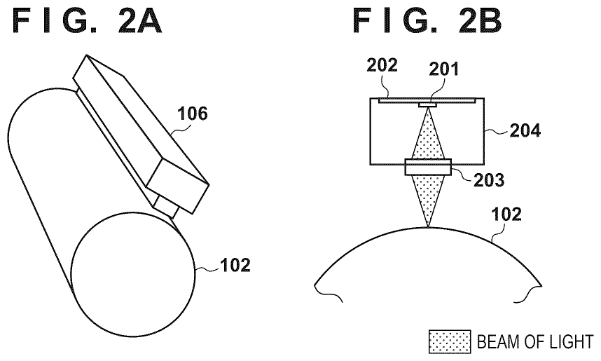

The exposure head 106, which exposes the photosensitive drum 102, will be described below. FIGS. 2A and 2B are diagrams illustrating an exposure head and a photosensitive drum. FIG. 2A is a diagram showing arrangement of the exposure head 106 relative to the photosensitive drum 102. FIG. 2B shows a diagram in which light emitted from a light-emitting element group 201 is collected on the photosensitive drum 102 due to a rod lens array 203.

The exposure head 106 and the photosensitive drum 102 are attached to the image forming apparatus 10 by attachment members (not illustrated). The exposure head 106 includes the light-emitting element group 201, a printed circuit board 202, the rod lens array 203, and a housing 204. The light-emitting element group 201 includes a plurality of arranged light-emitting elements. The light-emitting elements are, for example, semiconductor light-emitting elements or light-emitting diodes (LEDs) such as organic electro luminescence (EL) elements. The light-emitting element group 201 is mounted on the printed circuit board 202. The rod lens array 203 is disposed on the optical path of light emitted from the light-emitting element group 201. The rod lens array 203 includes a plurality of arranged rod lenses. The housing 204 holds the light-emitting element group 201, the printed circuit board 202, and the rod lens array 203.

When printing an image, the light-emitting elements on the chip surface of the light-emitting element group 201 of the exposure head 106 emit light according to image data. The rod lens array 203 collects the light emitted by the light-emitting element group 201 onto the photosensitive drum 102. Accordingly, an electrostatic latent image is formed on the photosensitive drum 102.

In a factory, an operation of adjusting the exposure head 106 is independently performed. In the adjustment operation, focus adjustment and light intensity adjustment for adjusting a spot at a light collecting position of the exposure head 106 to a predetermined size are performed. Here, the photosensitive drum 102 and the rod lens array 203 are disposed at a predetermined distance from each other, and the rod lens array 203 and the light-emitting element group 201 are disposed at a predetermined distance from each other, and thus light emitted from the light-emitting element group 201 forms an image on the photosensitive drum 102. For this reason, during focus adjustment, the attachment position of the rod lens array 203 is adjusted such that the distance between the rod lens array 203 and the light-emitting element group 201 takes a desired value. In addition, during light intensity adjustment, the light-emitting elements individually and sequentially emit light, and drive currents of the light-emitting elements are adjusted such that light collected via the rod lens array 203 reaches a predetermined light intensity.

### Configuration of Board

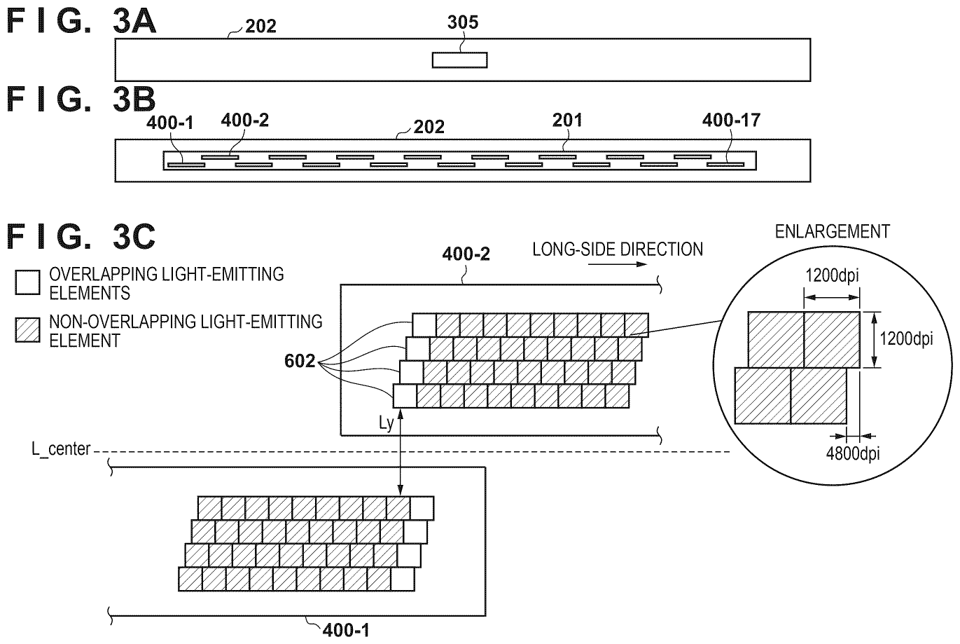

FIGS. 3A to 3C are plan views of the printed circuit board 202 on which the light-emitting element group 201 and a connector 305 are arranged. FIG. 3A is a plan view of the surface opposite to the surface on which the light-emitting element group 201 is mounted (hereinafter, referred to as a “light-emitting element non-mounted surface”). FIG. 3B is a plan view of the surface on which the light-emitting element group 201 is mounted (hereinafter, referred to as a “light-emitting element mounted surface”).

The light-emitting element group 201 has a configuration in which 17 light-emitting element array chips 400-1 to 400-17 are arranged on the printed circuit board 202 in a staggered manner. Note that, when there is no need to distinguish the light-emitting element array chips 400-1 to 400-17 from each other, the light-emitting element array chips 400-1 to 400-17 are each referred to as a “light-emitting element array chip 400”. The direction in which the light-emitting element array chips 400 are arranged is an example of an arrangement direction. The light-emitting element group 201 includes a plurality of light-emitting element array chips 400 arranged on the surface of the printed circuit board 202, and thus can be described as a surface light-emitting device. On each light-emitting element array chip 400, light-emitting elements functioning as 748 light-emitting points are arranged along the long-side direction at a predetermined pitch corresponding to the resolution of the chips. In the present embodiment, the pitch of the light-emitting elements adjacent to each other in the chip long-side direction is a pitch corresponding to resolution of 1200 dpi (about 21.16 μm), and the end-to-end distance of the 748 light-emitting elements in the light-emitting element array chip 400 is about 15.8 mm. The 17 light-emitting element array chips 400 are arranged as the light-emitting element group 201. Accordingly, the number of light-emitting elements that can perform exposure in the light-emitting element group 201 is 12716, which makes it possible to form an image having an image width of approximately 267 mm. The light-emitting element array chips 400-1 to 400-17 are arranged in two staggered rows. The rows of the light-emitting element array chips 400 are arranged along the long-side direction of the printed circuit board 202.

FIG. 3C is an enlarged plan view of boundary portions between light-emitting element array chips. As described above, on each light-emitting element array chip 400, light-emitting elements 602 are arranged at an interval of 1200 dpi. Four rows of light-emitting elements 602 are arranged in the short-side direction. The rows of light-emitting elements 602 are shifted by about 5 μm (equivalent to 4800 dpi) in the long-side direction. The light-emitting elements 602 are arranged such that a distance Ly between light-emitting points (light-emitting elements 602) in the short-side direction of the exposure head 106 having the two staggered rows of light-emitting element array chips 400 is about 105 μm (equivalent to five pixels at 1200 dpi and 10 pixels at 2400 dpi). In addition, the light-emitting elements 602 are arranged such that some light-emitting elements 602 overlap each other between the light-emitting element array chips 400 in the long-side direction of the exposure head 106. In the present embodiment, four light-emitting elements 602 at an end portion of each light-emitting element array chip 400 overlap four light-emitting elements 602 at an end portion of an adjacent light-emitting element array chip 400. The overlap amount is not limited to four light-emitting elements 602. For example, the overlap amount may be determined based on the maximum amount of mounting variation of a mounting device (die bonder) such that there is no gap between the light-emitting elements 602 of adjacent light-emitting element array chips 400.

The connector 305 is disposed on the light-emitting element non-mounted surface of the printed circuit board 202. The connector 305 receives a control signal for controlling the light-emitting element array chips 400 output from the image controller unit, and connects a power supply line and the light-emitting element array chips 400 to each other. The light-emitting element array chips 400 are driven via the connector 305.

### Configuration of Light-Emitting Element Array Chip

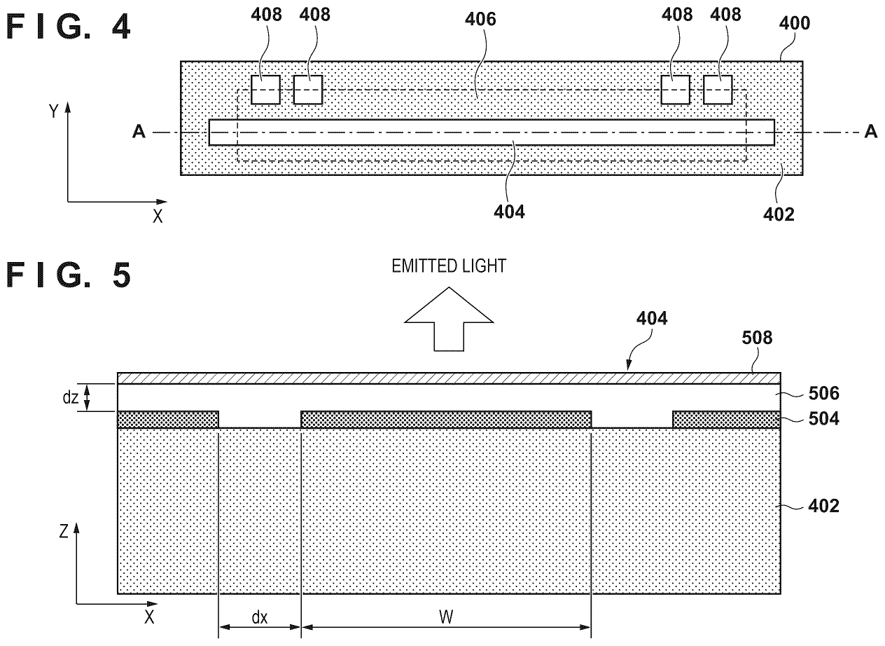

FIG. 4 is a plan view of a schematic configuration of a light-emitting element array chip 400. The light-emitting element array chip 400 includes a light-emitting substrate 402, a light-emitting portion 404, a circuit portion 406, and a plurality of WB pads 408.

The light-emitting substrate 402 may be a silicon substrate. Since the process technology for forming integrated circuits on silicon substrates has developed and silicon substrates have already been used as substrates for various integrated circuits, it is possible to form high-speed and highly-functional circuits at high density. In addition, silicon substrates are on the market as large-diameter wafers and have advantages such as being available at low cost.

The light-emitting portion 404 includes a plurality of light-emitting elements 602 provided on the light-emitting substrate 402.

The circuit portion 406 is incorporated in the light-emitting substrate 402. The circuit portion 406 controls the light-emitting portion 404. The circuit portion 406 may be an analog drive circuit, a digital control circuit, or a configuration including both circuits. In the present embodiment, the circuit portion 406 includes a drive portion for driving the light-emitting elements, a data transfer portion for generating a light-emission signal, and a light-emission signal generation portion. By being formed on a Si substrate, the circuit portion 406 becomes a high-speed circuit.

“WB” in the WB pads 408 is an abbreviation for wire bonding pad, and the WB pads 408 are provided on the light-emitting substrate 402. Power supply to the circuit portion 406 and input/output of signals and the like from/to the outside of the light-emitting element array chip 400 are performed via the WB pads 408.

### Configuration of Light-Emitting Portion

FIG. 5 is a cross-sectional view of a portion of the light-emitting portion 404 taken along the A-A line in FIG. 4. A configuration of the light-emitting portion 404 are described with reference to FIG. 5.

The light-emitting portion 404 includes a plurality of lower electrodes 504, a light-emitting layer 506, and an upper electrode 508. The plurality of lower electrodes 504, the light-emitting layer 506, and the upper electrode 508 are laminated on the light-emitting substrate 402. The lower electrodes 504 are independent electrodes provided for respective light-emitting elements (pixels). The light-emitting layer 506 is a layer that is provided commonly for the plurality of light-emitting elements, and emits light by an electric current flowing therethrough, for example. The upper electrode 508 is a common electrode commonly provided for the plurality of light-emitting elements. Each of the plurality of lower electrodes 504 is formed with a width W in the X direction in the figure and lower electrodes 504 adjacent in the X direction are spaced apart from each other by a predetermined distance dx. When a voltage is applied between the upper electrode 508 and the lower electrodes 504, a current flows from the lower electrodes 504 to the upper electrode 508. Accordingly, the light-emitting layer 506 between the upper electrode 508 and the lower electrodes 504 emits light. By increasing the distance dx between electrodes relative to a distance dz between the upper electrode 508 and the lower electrodes 504, it is possible to prevent a leakage current between adjacent lower electrodes 504 and prevent erroneous light emission of adjacent pixels.

In a process of manufacturing the light-emitting portion 404, the lower electrodes 504 are formed, and the light-emitting layer 506 is then formed on the lower electrodes 504. In the figure, the light-emitting layer 506 is formed over the entire surface in a continuous manner, but there is no limitation thereto. For example, the light-emitting layer 506 may be divided into pieces approximately equal in size to the lower electrodes 504. The light-emitting layer 506 may be, for example, an organic EL film. In a case where an organic EL film is used as the light-emitting layer 506, the light-emitting layer 506 may be a laminate structure that includes functional layers such as an electron transport layer, a hole transport layer, an electron injection layer, a hole injection layer, an electron blocking layer, and a hole blocking layer, as necessary. In addition, the light-emitting layer 506 may be an inorganic EL layer or the like, instead of an organic EL.

The light-emitting layer 506 is formed on the lower electrodes 504, and the upper electrode 508 is then formed on the light-emitting layer 506. The upper electrode 508 is transparent to a light-emission wavelength of the light-emitting layer 506. Therefore, the upper electrode 508 is a transparent electrode such as an indium tin oxide (ITO) electrode. In the present embodiment, a configuration will be described in which the entire upper electrode 508 is formed by a transparent electrode (ITO) as an example. Note that it suffices for the transparent electrode, that is, the upper electrode 508 to be formed at an opening portion from which light is emitted, and the upper electrode 508 does not necessarily need to entirely cover the light-emitting element array chip 400. For example, a configuration may also be adopted in which a transparent electrode is partially formed only in the opening portion, and electrodes other than the transparent electrode (metal wiring, etc.) are routed in portions other than the opening portion.

### Light-Emitting Portion Arrangement (High-Resolution Overlap Arrangement)

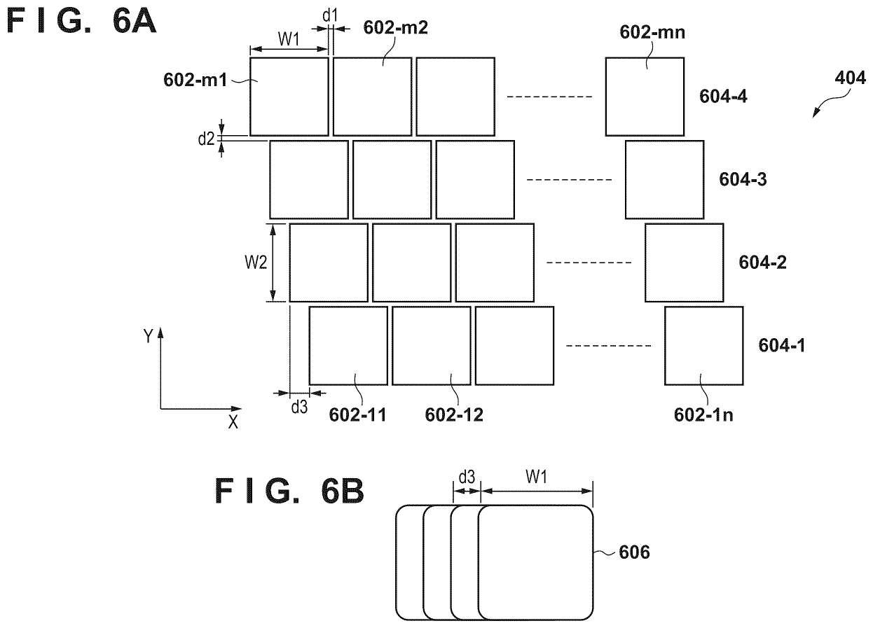

FIGS. 6A and 6B are plan views illustrating overlapping of light-emitting elements. The light-emitting portion 404 includes a plurality of light-emitting elements 602-11 to 602-mn. “m” and “n” are positive integers. When the plurality of light-emitting elements 602-11 to 602-mn do not need to be distinguished from each other, the light-emitting elements 602-11 to 602-mn are each referred to as a “light-emitting element 602”.

FIG. 6A is a plan view illustrating the arrangement of the plurality of light-emitting elements 602 of the light-emitting portion 404. The plurality of light-emitting elements 602 are arranged along the X direction in rows at a predetermined interval in the X direction in the figure, for example, at a pitch of 21.16 μm in a case of 1200 dpi. The rows in which the light-emitting elements 602 are arranged along the X direction are defined as light-emitting element rows 604-1 and 604-4. When the light-emitting element rows 604-1 and 604-4 do not need to be distinguished from each other, the light-emitting element rows 604-1 and 604-4 are each referred to as a “light-emitting element row 604”. The plurality of light-emitting elements 602 are also arranged in the Y direction at a predetermined pitch. The light-emitting elements 602 are arranged in a matrix of n light-emitting elements in the row direction (the X direction in the figure) and m light-emitting elements in a direction different from the row direction (the Y direction in the figure). In the present embodiment, four rows of light-emitting elements 602 are arranged in the Y direction, but it suffices for the light-emitting elements 602 to be arranged in two or more rows.

A width W1 in the figure is the width in the X direction of each light-emitting element 602. A width W2 in the Y direction of the light-emitting element 602 may be the same as the width W1, but is not limited to the same width. A distance d1 is the distance between light-emitting elements 602 adjacent in the X direction. A distance d2 is the distance between light-emitting elements 602 adjacent in the Y direction. Here, the distance d1 and the distance d2 represent the above distance dx between electrodes in two-dimensional coordinates. The distance d1 and the distance d2 are determined to be larger than the distance dz between the upper electrode 508 and the lower electrodes 504. The positions of the light-emitting element rows 604-1 to 604-4 are shifted in the X direction. In the present embodiment, a positional shift amount d3 of the light-emitting element rows 604 is 5 μm (equivalent to 4800 dpi).

In this manner, the light-emitting element rows 604 are arranged in the Y direction. By the light-emitting element rows 604 emitting light at different light emission timings, an image can be formed on the same line on the photosensitive drum 102. FIG. 6B shows light spots 606 of the light-emitting element rows 604 when light emission timings of the light-emitting element rows 604 are shifted to expose the same row on the photosensitive drum 102. The actual width of each light spot 606 is larger than the width W1 of the light-emitting element 602 by being affected by a lens being out of focus, or the like, but, in this example, in order to simplify the description, a description will be given assuming that the width of the light spot 606 is substantially the same as the width W1. The latent image potential on the photosensitive drum 102 formed by the light spots 606 of the respective light-emitting elements 602 forms a smooth latent image due to sudden potential variation between light-emitting elements 602 being eliminated by adjacent light-emitting elements 602 overlapping each other. If the width W1 of each of the light-emitting elements 602 is small, the amount of overlap of light spots 606 is small, and gaps are formed between light spots 606, which causes an image defect such as image streaks. The width W1 in the present embodiment is at least twice the positional shift amount d3 of the light-emitting element rows 604. Accordingly, the light spot 606 of each of the light-emitting elements 602 overlaps not only the light spot 606 of an adjacent light-emitting element 602, but also the light spot 606 of a second adjacent light-emitting element 602. As a result, according to the present embodiment, it is possible to increase the resistance to image streaks.

### Control Blocks

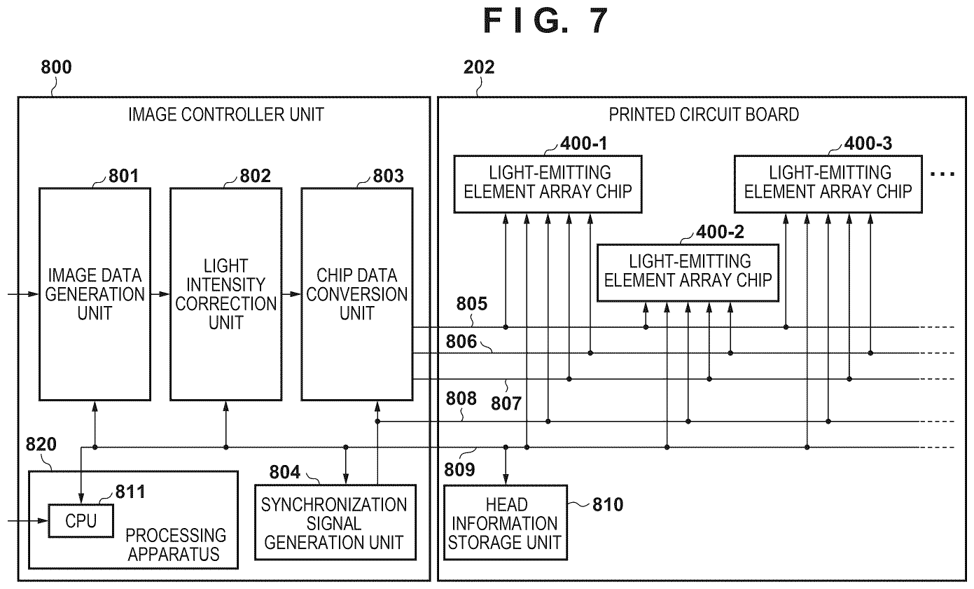

FIG. 7 is a block diagram illustrating a control system of the image forming apparatus 10. The image forming apparatus 10 further includes an image controller unit 800 electrically connected to the printed circuit board 202. In the present embodiment, processing for a single color will be described in order to simplify the description, but similar processing may be performed in parallel for the four colors simultaneously.

The image controller unit 800 transmits signals for controlling the printed circuit board 202. The signals that are transmitted by the image controller unit 800 include a chip select signal indicating a valid area of image data, a clock signal, image data, a line synchronization signal indicating a delimiter for each line of image data, and a communication signal for communication with a CPU 811 of a processing apparatus 820. Those signals are transmitted to the light-emitting element array chips 400 in the printed circuit board 202 via one of a chip select signal line 805, a clock signal line 806, an image data signal line 807, a line synchronization signal line 808, and a communication signal line 809.

The image controller unit 800 performs processing on image data and processing on print timings. The image controller unit 800 includes an image data generation unit 801, a light intensity correction unit 802, a chip data conversion unit 803, a synchronization signal generation unit 804, and the processing apparatus 820 that includes the CPU 811. The processing apparatus 820 is an example of an information processing apparatus. Some or all of the functions of the image data generation unit 801, the light intensity correction unit 802, the chip data conversion unit 803, and the synchronization signal generation unit 804 may be realized by one or more circuits that include an application specific integrated circuit (ASIC) and a programmable logic device (PLD) including a field programmable gate array (FPGA).

The image data generation unit 801 performs dithering processing on image data obtained from the scanner unit 100 or from the outside of the image forming apparatus 10, at resolution instructed by the CPU 811. Accordingly, the image data generation unit 801 generates image data to be printed. In the present embodiment, the image data generation unit 801 performs dithering processing at the resolution of 1200 dpi in the sub-scanning direction and at the resolution of 4800 dpi in the main scanning direction.

The light intensity correction unit 802 performs light intensity correction on image data subjected to dithering processing, based on a light intensity correction value obtained from the CPU 811. The light intensity correction unit 802 inserts and extracts image data at each main scanning position in the chips to correct light intensity variation in the chips.

The synchronization signal generation unit 804 performs determination on a delimiter of each line of image data, generates a line synchronization signal, and provides the line synchronization signal to the line synchronization signal line 808.

The chip data conversion unit 803 divides image data for one line into segments corresponding to the respective light-emitting element array chips 400 in synchronization with the line synchronization signal generated by the synchronization signal generation unit 804, and transmits the segments to the printed circuit board 202 along with a chip select signal indicating which light-emitting element array chip 400 is to receive which portion of the image data.

“CPU” of the CPU 811 is an abbreviation for Central Processing Unit, and the CPU 811 executes various types of computation processing. The CPU 811 is an example of first correction means and second correction means. The CPU 811 generates light intensity correction data based on image reading values input from the scanner unit 100, and outputs the light intensity correction data to the light intensity correction unit 802 and the light-emitting element array chips 400. For example, the CPU 811 generates correction data (first correction data) for correcting the light intensity differences at boundaries between adjacent light-emitting element array chips 400. The CPU 811 generates correction data (second correction data) for correcting light intensity distribution of the exposure head in which the light intensity differences at the boundaries have been corrected using the correction data. In the light-emitting element array chips 400, a set current of an incorporated reference current source is set in accordance with an instruction from the CPU 811, and overall control is performed on the light intensity of the light-emitting element array chips 400.

The CPU 811 gives an instruction on a time interval of a signal cycle to the synchronization signal generation unit 804, defining, as one line cycle, a period during which the surface of the photosensitive drum 102 moves in the rotation direction by a distance corresponding to a pixel size of 1200 dpi (approximately 21.2 μm) at a predetermined rotational speed of the photosensitive drum 102. For example, in a case of printing at a speed of 200 mm/s in the paper conveyance direction, the CPU 811 instructs the synchronization signal generation unit 804 to operate at the time interval of 105.8 μs (with decimal places beyond the second omitted) as one line cycle. The CPU 811 calculates the speed in the paper conveyance direction using a set value (fixed value) for a printing speed that is set in a speed control unit (not illustrated) of the photosensitive drum 102.

Next, a configuration of the printed circuit board 202 will be described. The printed circuit board 202 further includes a head information storage unit 810.

The head information storage unit 810 is a storage device that stores head information such as light emission amounts of the respective light-emitting element array chips 400 and position information indicating positions where the respective light-emitting element array chips 400 are mounted. The head information storage unit 810 is connected to the CPU 811 via the communication signal line 809.

The clock signal line 806, the image data signal line 807, the line synchronization signal line 808, and the communication signal line 809 are connected to each of the light-emitting element array chips 400. The chip select signal line 805 includes 17 bus signal lines, which respectively correspond to the light-emitting element array chips 400-1 to 400-17, and thereby signals are transmitted. The chip data conversion unit transfers image data to the light-emitting element array chips 400 one line at a time based on a line synchronization signal. Data can be written to the 17 light-emitting element array chips 400 by a chip select signal transmitted from the chip data conversion unit 803 transitioning from Low to High. The chip data conversion unit 803 sequentially raises the chip select signal to High and transfers corresponding image data to the light-emitting element array chips 400, and thereby image data is transferred one line at a time. After the image data is received, a light emission operation corresponding to the image data is performed in the light-emitting element array chips 400 at the input timing of the next line synchronization signal.

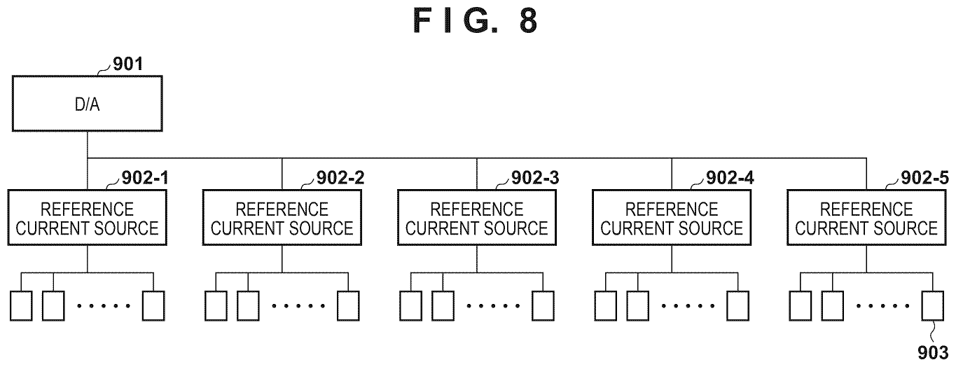

FIG. 8 is a block diagram of the internal circuit of each light-emitting element array chip 400. The internal circuit of the light-emitting element array chip 400 includes a D/A 901 and reference current sources 902-1 to 902-5. When the reference current sources 902-1 to 902-5 do not need to be distinguished from each other, the reference current sources 902-1 to 902-5 are each referred to as a “reference current source 902”. The D/A 901 is a D/A converter, and generates an analog voltage based on data designated by the CPU 811. The light-emitting element array chip 400 is divided into multiple blocks in the long-side direction, and the analog voltage generated by the D/A 901 is delivered to the reference current sources 902-1 to 902-5 of the blocks. The reference current sources 902 of the blocks each generate a reference current using the analog voltage, and provides the reference current to light-emitting elements 903 of the light-emitting element array chip 400. That is to say, the currents of the light-emitting elements 903 are determined by the reference current sources 902 of the blocks. In the present embodiment, an example has been given in which each light-emitting element array chip 400 is divided into five blocks, which respectively use the reference current sources 902, but the number of blocks may be changed depending on wiring distances in the long-side direction of the chips and the drive capability of the reference current sources 902.

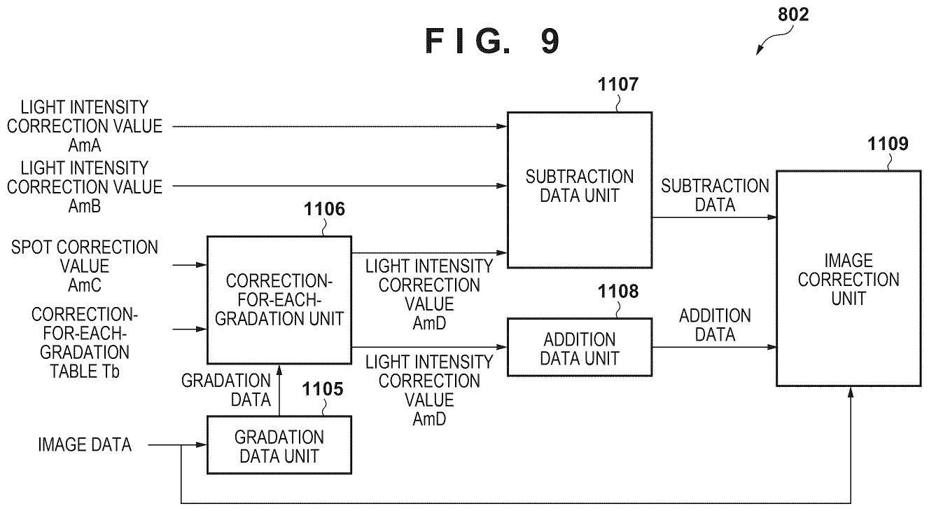

Light Intensity Correction Unit 802 FIG. 9 is a block diagram illustrating a configuration of the light intensity correction unit 802. The light intensity correction unit 802 generates image data for correcting density variation that occurs, using a light intensity correction value AmA, a light intensity correction value AmB, and a spot correction value AmC. Current variation that occurs due to differences between blocks in the circuit of the light-emitting element array chip 400 is addressed using the light intensity correction value AmA. Light intensity variation that occurs due to variation in the light emission efficiency of lenses in the long-side direction is addressed using the light intensity correction value AmB. Density variation caused by variation of the spots in the long-side direction is addressed using the spot correction value AmC. The light intensity correction value AmA, the light intensity correction value AmB, and the spot correction value AmC are set and output by the CPU 811, for example.

The light intensity correction unit 802 includes a gradation data unit 1105, a correction-for-each-gradation unit 1106, a subtraction data unit 1107, an addition data unit 1108, and an image correction unit 1109.

The gradation data unit 1105 obtains image data subjected to dithering processing performed by the image data generation unit 801. The gradation data unit 1105 reads gradation values from the obtained image data, and outputs gradation data to the correction-for-each-gradation unit 1106.

The correction-for-each-gradation unit 1106 obtains the gradation data output by the gradation data unit 1105, the spot correction value AmC, and a light intensity correction-for-each-gradation table Tb. The spot correction value AmC is a value for performing processing to address a case where spots partially enlarge in the main scanning direction, and a density variation amount differs for each gradation level. In the light intensity correction-for-each-gradation table Tb, light intensity correction values AmD that were set in advance are associated with spot correction values AmC and gradation data of image data. The correction-for-each-gradation unit 1106 refers to the light intensity correction-for-each-gradation table Tb, and extracts the light intensity correction value AmD associated with the obtained spot correction value AmC and gradation data. When increasing light intensity, the correction-for-each-gradation unit 1106 outputs the extracted light intensity correction value AmD to the addition data unit 1108. When decreasing light intensity, the correction-for-each-gradation unit 1106 outputs the extracted light intensity correction value AmD to the subtraction data unit 1107.

The subtraction data unit 1107 calculates subtraction data for decreasing light intensity based on the light intensity correction value AmA, the light intensity correction value AmB, and the light intensity correction value AmD, and outputs the calculated subtraction data to the image correction unit 1109. The subtraction data unit 1107 may calculate a total value of subtraction based on the light intensity correction value AmA, the light intensity correction value AmB, and the light intensity correction value AmD, as subtraction data, for example.

The addition data unit 1108 outputs obtained addition data to the image correction unit 1109.

The image correction unit 1109 obtains subtraction data calculated by the subtraction data unit 1107, addition data output by the addition data unit 1108, and image data subjected to dithering processing performed by the image data generation unit 801. The image correction unit 1109 corrects an image using the subtraction data, addition data, and image data, and thereby generates an image after correction (hereinafter, also referred to as a “corrected image”).

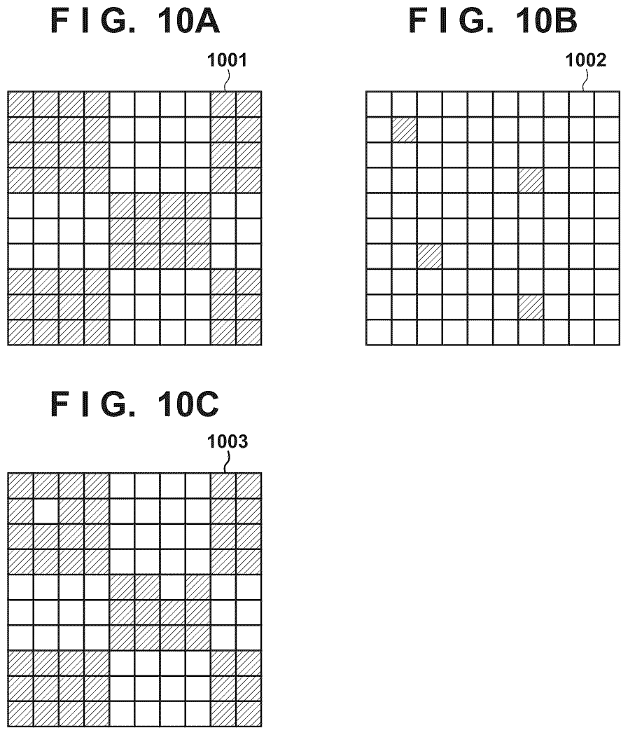

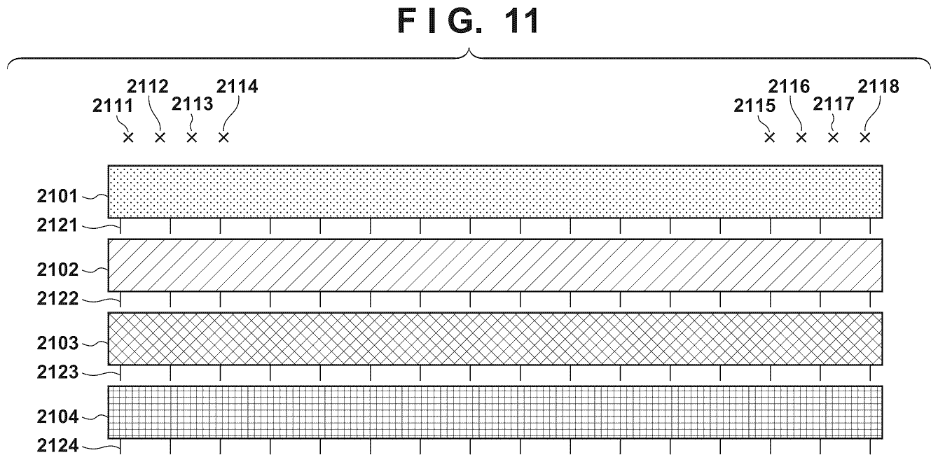

FIGS. 10A to 10C are diagrams illustrating a process of correcting an image. FIG. 10A shows an example of an image before correction (hereinafter, an image before correction 1001). The image before correction 1001 shown in FIG. 10A may be a portion of an image to be corrected. FIG. 10B shows an image for correction (hereinafter, an “image for correction 1002”). FIG. 10C shows a corrected image 1003.

The image correction unit 1109 obtains the image before correction 1001 of a predetermined image size. The image correction unit 1109 generates the image for correction 1002 that includes positive and negative signs due to subtraction data and addition data. Furthermore, the image correction unit 1109 processes the image for correction 1002 for a predetermined image size. For example, the image correction unit 1109 calculates a light intensity correction ratio per unit area according to either the obtained subtraction data or addition data, and selects pixels to be added or subtracted for the predetermined image size. Specifically, when subtracting the light intensity by 4%, the image correction unit 1109 selects four pixels from 10×10 pixels (100 pixels in total) as subtraction data, as shown in the figure. Based on the selected four pixels, the image correction unit 1109 performs subtraction processing on the light-emitting pixels of the image before correction 1001, and generates the corrected image 1003.

As an example of a method for generating the image for correction shown in FIG. 10B, the image correction unit 1109 may determine the number and positions of correction pixels in correspondence with a correction amount using a threshold matrix table. In the commonly known blue noise mask method, image data is generated using a threshold matrix table that has high spatial frequency characteristics. In the present embodiment, the image correction unit 1109 generates a high spatial frequency image for correction 1002 using the blue noise mask method, and adds or subtracts the generated image for correction 1002 to or from the image before correction 1001. The image correction unit 1109 selects pixels to be corrected by determining the correction positions corresponding to the correction amount using the threshold matrix table. In the present embodiment, the threshold matrix table has a 10×10 pixel size, and stores ON and OFF threshold data for correction amounts. If a correction amount at each pixel position exceeds a threshold value of the corresponding pixel in the threshold matrix table, the image correction unit 1109 determines that the pixel is to be corrected. The image correction unit 1109 corrects the light intensity in the entire region in the long-side direction by repeating the aforementioned processing in the units of 10×10 pixels in the long-side direction. Note that the same settings are repeatedly used for the threshold matrix table that is used, and the image correction unit 1109 sets a different correction amount according to a position in the long-side direction. The image correction unit 1109 corrects the light intensity using any suitable correction amount for a predetermined position in the long-side direction by performing the above operation.

The image correction unit 1109 can realize highly accurate light intensity correction by making the correction resolution sufficiently finer relative to the dot size of the image before correction 1001. In the present embodiment, the image correction unit 1109 performs addition and subtraction on an image at 4800 dpi in the main scanning direction and 2400 dpi in the sub-scanning direction. An example has been described in which an image is processed in the units of 10×10 pixels, but the image correction unit 1109 may designate insertion and extraction sites in an image of a larger size. When using the blue noise mask method, processing may be performed in units of 128×128 pixels or 256×256 pixels. By increasing the image size for processing, it is possible to randomly disperse the spatial frequencies of the insertion and extraction sites, and prevent the occurrence of interference moiré between the original image and the insertion and extraction pixel cycles. In addition, the light intensity correction unit 802 performs processing before the chip data conversion unit 803. The chip data conversion unit 803 divides image data in the main scanning direction for each light-emitting element array chip 400, and thus it is more preferable for the light intensity correction unit 802 to perform correction processing upstream of the chip data conversion unit 803, to continuously perform processing in the main scanning direction.

### Method for Generating Light Intensity Correction Data by Light Measurement

In the present embodiment, light intensity correction is executed by adjusting a current for each chip to address light intensity variation in the long-side direction, and light intensity adjustment that uses image data is executed to address light intensity variation that is smaller than a chip. There are two methods for obtaining data for correction: a method for performing measurement during an assembly and adjustment process of the exposure head 106 to obtain the data for correction and a method for obtaining the data for correction within the image forming apparatus 10. Light intensity data obtained by performing measurement in the assembly and adjustment process is stored in the head information storage unit 810 in the printed circuit board 202. The CPU 811 reads out the light intensity data from the head information storage unit 810.

The CPU 811 sets, in the D/A 901, a correction value for each light-emitting element array chip calculated based on the read light intensity data. The CPU 811 sets the light intensity correction value AmA for light intensity variation that is smaller than the width of a light-emitting element array chip, in the light intensity correction unit 802. Note that the CPU 811 may set the light intensity correction value AmB and the spot correction value AmC for current variation, in the light intensity correction unit 802. Accordingly, the image correction unit 1109 of the light intensity correction unit 802 corrects the image.

Among the correction values that the CPU 811 sets in the light intensity correction unit 802, the spot correction value AmC is a component of local variation of an image forming spot. Therefore, under the condition that all of the light-emitting elements are turned on, the spot correction value AmC is not measured as a component of light intensity variation. Therefore, in a process of calculating setting values of the D/A 901, the CPU 811 does not use the component of local variation of an image forming spot. Under the condition that all of the light-emitting elements 602 are turned on, the CPU 811 measures the light intensity value of each light-emitting element array chip, and adjusts the values of the D/A 901 such that the light-emitting element 602 whose light intensity is the lowest in the light-emitting element array chip 400 is set as a predetermined target light intensity. The subtraction data unit 1107 of the light intensity correction unit 802 determines a light intensity value to be subtracted, as subtraction data. If the correction amount for values of image data is large, image damage, that is, collapse of a dot shape occurs, and thus the CPU 811 performs determination such that the size of subtraction data is small, and, for example, the CPU 811 determines a minimum value as the correction amount. The CPU 811 adjusts the values of the D/A 901 such that the light-emitting element 602 whose light intensity is the lowest in the light-emitting element array chip 400 serves as a predetermined target light intensity. Accordingly, the D/A 901 coarsely adjusts the light intensity, and the light intensity correction unit 802 corrects only the component of light intensity variation within the surface of the light-emitting element array chip 400.

In addition, regarding the component of local variation of an image forming spot, the amount of variation of can be read by the light-emitting elements 602 discretely emitting light. For example, by causing one light-emitting point to emit light, and causing a charge coupled device (CCD) camera to read an image forming spot at the image forming position of the exposure head, the image forming spot is measured. In the present embodiment, an image forming spot is measured in an assembly process, and the amount of local variation of the image forming spot and the position of the occurrence of the variation are stored in the head information storage unit 810.

As described above, by performing light measurement in the assembly and adjustment process, the light intensity can be uniformized, but, also within the image forming apparatus 10, light intensity adjustment can be performed by causing the scanner unit 100 to read a printed light intensity correction chart. A light intensity adjustment method that uses the scanner unit 100 will be described below. In the light intensity adjustment method that uses the scanner unit 100, the setting values of the D/A 901 are adjusted based on a result of the scanner unit 100 reading an image, and a result of detecting the density difference between light-emitting element array chips 400. In addition, after the density difference between light-emitting element array chips 400 is adjusted, density variation in the entire region in the long-side direction of the image is measured, and the CPU 811 sets density variation as the light intensity correction value AmB, whereby the density of the image is uniformized in the long-side direction.

### Method for Generating Light Intensity Correction Data Using Light Intensity Correction Chart 1. Correction Chart, Light Intensity Conversion Method, and Method for Checking Focus Jumping

Next, a method for obtaining correction data within the image forming apparatus 10 will be described.

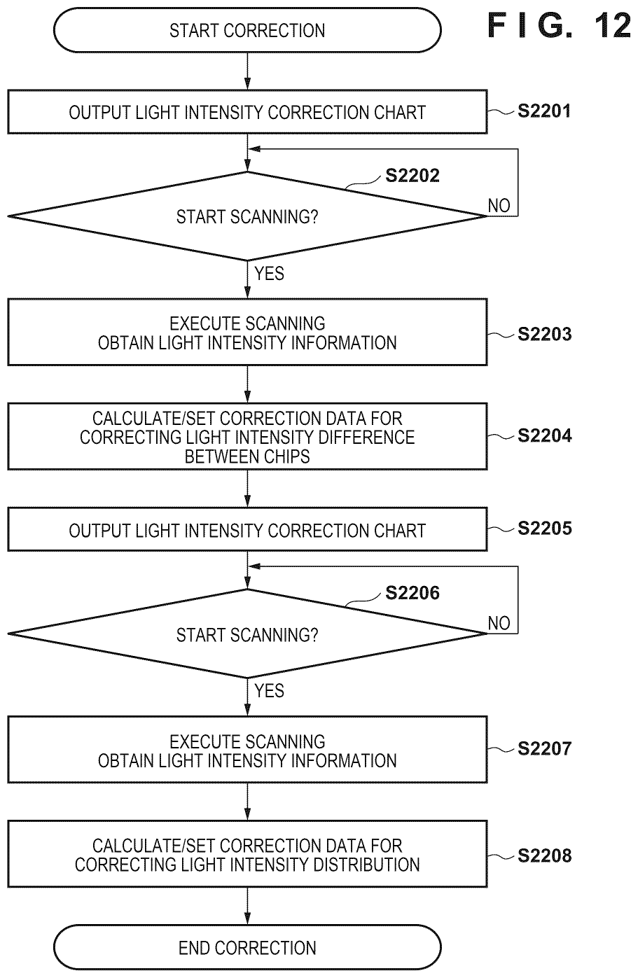

FIG. 11 is a diagram of a light intensity correction chart that is printed in order to obtain light intensity variation. When an instruction to perform correction processing for adjusting light intensity variation is given using a user interface, the light intensity correction chart is printed. The user causes the scanner unit 100 to read the printed light intensity correction chart, and light intensity correction data is thereby generated within the image forming apparatus 10.

The light intensity correction chart includes band-shaped images 2101 to 2104 that extend in the long-side direction and respectively correspond to the four colors Y (yellow), M (magenta), C (cyan), and K (black) and reference marks 2121 to 2124. The reference marks 2121 to 2124 are disposed in correspondence with the images 2101 to 2104. The reference marks 2121 to 2124 are marks for specifying the positions of the light-emitting element array chips 400. The reference marks 2121 to 2124 are printed by pixels at end portions of the light-emitting element array chips 400 emitting light. In the present embodiment, the 17 light-emitting element array chips 400 are arranged, and thus the reference marks 2121 to 2124 are printed in correspondence with 16 boundary portions between the light-emitting element array chips 400. The CPU 811 can calculate boundary positions between the light-emitting element array chips 400 by calculating the centroid position of the reference marks 2121 to 2124 read by the scanner unit 100, and, even if the light intensity correction chart is displaced relative to paper, the CPU 811 can accurately calculate the positions of the light-emitting element array chips 400 relative to the image.

The CPU 811 converts a sensor signal read by the scanner unit 100 (luminance signal from the CCD sensor) into density information using a predetermined transform coefficient, and converts the density information into light intensity information. This conversion processing is also called density light intensity conversion processing. When converting density information into light intensity information, the CPU 811 may use a transform coefficient experimentally obtained in advance. The relationship between density and light intensity may change according to a temperature condition and a humidity condition in the surroundings of the image forming apparatus 10. Therefore, the image forming apparatus 10 according to the present embodiment stores, in advance, a transform coefficient that changes according to a temperature condition and a humidity condition. Accordingly, the image forming apparatus 10 can accurately obtain light intensity information by using a transform coefficient corresponding to temperature and humidity conditions. In such a case, the image forming apparatus 10 further includes a temperature sensor and a humidity sensor, detects temperature information and humidity information when outputting a light intensity correction chart, and uses the detected information for correction.

If the distance between the exposure head 106 and the photosensitive drum 102 deviates from a predetermined distance, focus of light that is collected by the exposure head 106 shifts, and thus abnormal density may occur. In particular, if the distances from the photosensitive drum 102 to two end portions of the exposure head 106 are different, a large density difference occurs between the two end portions of the exposure head 106. The change amount of density variation caused by defocus differs according to gradation of an image and the size of the dots to be printed, and thus may not be fully compensated for by light intensity correction. In the present embodiment, focus detection marks 2111 to 2118 for detecting focus misalignment are printed. The light intensity correction chart includes, at the left end thereof, the focus detection marks 2111 to 2114 corresponding to the colors Y, M, C, and K. The light intensity correction chart includes, at the right end thereof, the focus detection marks 2115 to 2118 corresponding to the colors Y, M, C, and K. The focus detection marks 2111 to 2118 are images of two lines that extend along diagonal directions and intersect each other. The lines in the diagonal directions are sensitive to variations in the light spot sizes in the main scanning direction and the sub-scanning direction, and disappear when the light spot enlarges. In addition, the intersections of the lines are printed darker (densely) than the other parts of the lines. Accordingly, by comparing the image density at the end portions of the focus detection marks 2115 to 2118 with the image density at the intersections, it is possible to detect the degree to which the light spot has enlarged. In the present embodiment, the CPU 811 determines whether the amount of enlargement of the light spot is within an allowable range based on the results of the scanner unit 100 reading the focus detection marks 2115 to 2118, and if it is outside the allowable range, may end a series of light intensity adjustment operations and notify the user of the abnormal state by an image or sound.

2. Description of Correction Processing: Long-Period Variation is Corrected after Correcting Light Intensity Differences Between Chips

FIG. 12 is a diagram of a flowchart of correction processing for generating correction data for correcting light intensity. When the user gives an instruction to start density variation correction processing of light intensity via a user interface such as a touch panel, the CPU 811 starts correction processing.

In step S2201, the CPU 811 prints and outputs the light intensity correction chart shown in FIG. 11, and advances the procedure to step S2202.

In step S2202, the CPU 811 receives an instruction to start scanning, and determines whether or not to start scanning. For example, the user sets the output light intensity correction chart in the scanner unit 100, and gives an instruction to start scanning via the user interface. Upon receiving the instruction to start scanning from the user, the CPU 811 determines that scanning is to be started, and advances the procedure to step S2203. Note that the CPU 811 waits until it is determined that scanning is to be started.

In step S2203, the CPU 811 scans the light intensity correction chart, obtains light intensity information based on the result of reading the light intensity correction chart, and calculates light intensity. The procedure advances to step S2204. The light intensity information may be information regarding light intensity or density for calculating light intensity. Specific calculation of light intensity will be described later.

In step S2204, the CPU 811 calculates light intensity differences at boundaries between the light-emitting element array chips 400, calculates correction data (an example of first correction data) for correcting the light intensity differences, and performs setting of the D/A 901 that supplies a drive current to each of the light-emitting element array chips 400, and thereby corrects the light intensity differences between the light-emitting element array chips 400.

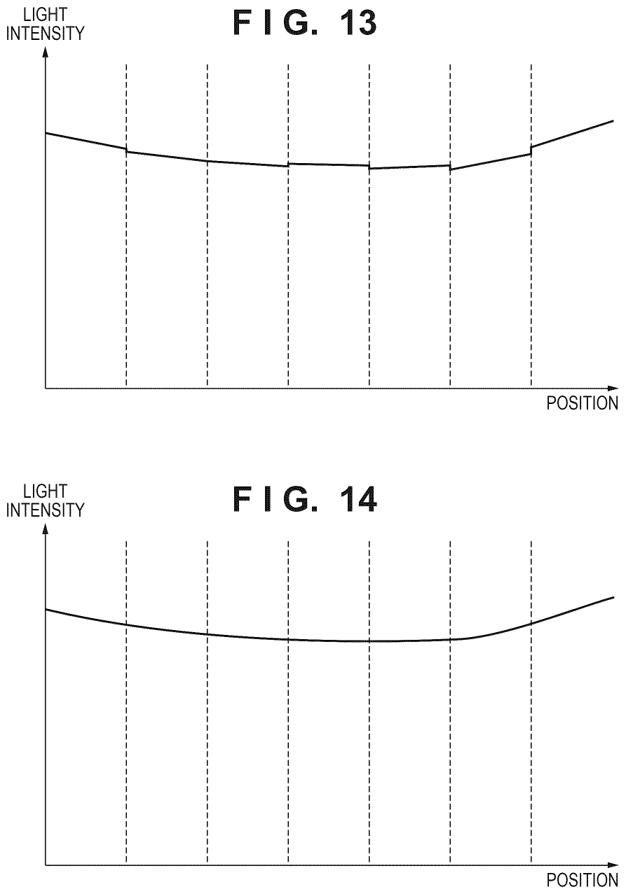

FIG. 13 is a diagram of light intensity distribution of the exposure head 106 before correction of the light-emitting element array chips 400 in the long-side direction. FIG. 14 is a diagram of light intensity distribution of the exposure head 106 after correction of the light-emitting element array chips 400 in the long-side direction. The vertical axes in FIGS. 13 and 14 indicate the light intensity of light-emitting element array chips 400. The horizontal axes in FIGS. 13 and 14 indicate the positions in the long-side direction of the light-emitting element array chips 400. Therefore, FIGS. 13 and 14 indicate light intensity distribution of the positions of the light-emitting element array chips 400. The dashed lines in FIGS. 13 and 14 indicate the boundaries between adjacent light-emitting element array chips 400. Therefore, space between two dashed lines indicates one light-emitting element array chip 400. Note that correction in FIGS. 13 and 14 is correction of light intensity differences at the boundaries between the light-emitting element array chips 400.

In the present embodiment, the number of light-emitting element array chips 400 of the exposure head 106 is 17, and thus light intensity distribution for 17 chips is obtained, but, in order to simplify the figure, FIG. 13 shows light intensity distribution of 7 chips at a central portion. In the light intensity distribution before correction shown in FIG. 13, there are sharp light intensity differences at boundaries between the light-emitting element array chips 400 indicated by the dashed lines. In step S2204, the CPU 811 generates correction data for reducing the light intensity differences between the light-emitting element array chips 400, and corrects the light intensity. Accordingly, in the light intensity distribution after correction shown in FIG. 14, the sharp light intensity differences at the boundaries between the light-emitting element array chips 400 indicated by the dashed lines are corrected, the steps at the boundaries are reduced, and the boundaries are smoothed.

The processing of the subsequent steps S2205 to S2207 is similar to processing of steps S2201 to S2203, and thus will be briefly described.

In step S2205, the CPU 811 prints the light intensity correction chart shown in FIG. 11, and advances the procedure to step S2206. Here, the CPU 811 corrects the light intensity of light-emitting element array chips 400 using the correction data calculated in step S2204, and prints the light intensity correction chart in which the light intensity differences at boundaries have been reduced.

In step S2206, the CPU 811 waits until an instruction to start scanning from the user is accepted. Upon accepting an instruction to start scanning from the user, the CPU 811 determines that scanning is to be started, and advances the procedure to step S2207.

In step S2207, the CPU 811 scans the light intensity correction chart, obtains light intensity information based on the result of reading the light intensity correction chart, and advances the procedure to step S2208. Here, the CPU 811 obtains the light intensity information by scanning the printed light intensity correction chart in which the light intensity of the light-emitting element array chips 400 have been corrected based on the correction data generated in step S2204. Therefore, as shown in FIG. 14, the light intensity information that is obtained by the CPU 811 is gradual light intensity distribution in which the boundaries between the light-emitting element array chips 400 have no steps.

In step S2208, the CPU 811 calculates and sets correction data (an example of second correction data) for correcting light intensity distribution of a plurality of predetermined sample areas in the light-emitting element array chips 400 based on the light intensity information. The light intensity distribution that is a correction target is light intensity distribution that covers a plurality of light-emitting element array chips 400. Here, the light intensity distribution that is a correction target is light intensity distribution that covers all of the light-emitting element array chips 400, in other words, light intensity distribution of the entire exposure head 106. The CPU 811 sets correction data for that light intensity distribution, as correction data of the light intensity correction value AmB for correcting light intensity variation.

As described above, in the present embodiment, the light intensity differences at boundaries between the light-emitting element array chips 400 are corrected, and then the light intensity distribution of the entire exposure head 106 is corrected based on the light intensity correction chart printed based on the correction. Through correction of the light intensity distribution of the entire exposure head 106, the CPU 811 corrects gradual variations and thus achieves flatter light intensity distribution. For example, the CPU 811 generates correction data obtained by approximating the light intensity distribution of the entire exposure head 106 using a quadratic function or the like. The quadratic function in this context is, for example, a function that expresses the relationship between a position in the long-side direction of the exposure head 106 and the light intensity at that position. In the present embodiment, it is possible to increase the accuracy of approximation of light intensity distribution by first correcting sharp light intensity differences at the boundaries between light-emitting element array chips 400.

Averaging Method in Sub-Scanning Direction for Obtaining Light Intensity Information within Chips in Step S2203

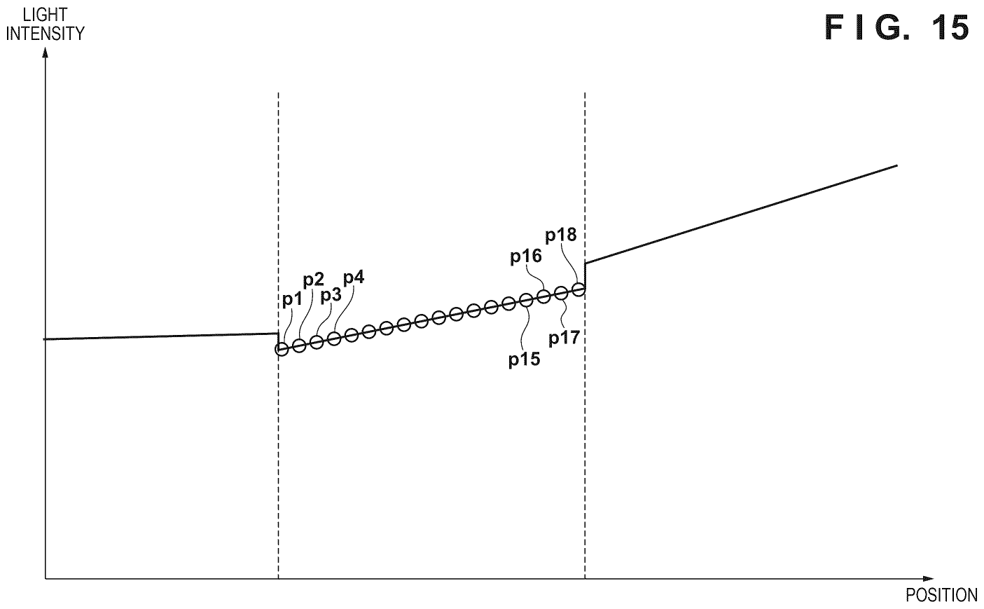

FIG. 15 is a diagram of the light intensity distribution before correction of the light-emitting element array chips 400 obtained in step S2203. In the present embodiment, the scanner unit 100 scans the light intensity correction chart that is a two-dimensional band-shaped image, and the CPU 811 calculates one-dimensional light intensity information corresponding to positions in the long-side direction in the exposure head 106 based on the two-dimensional light intensity correction chart.

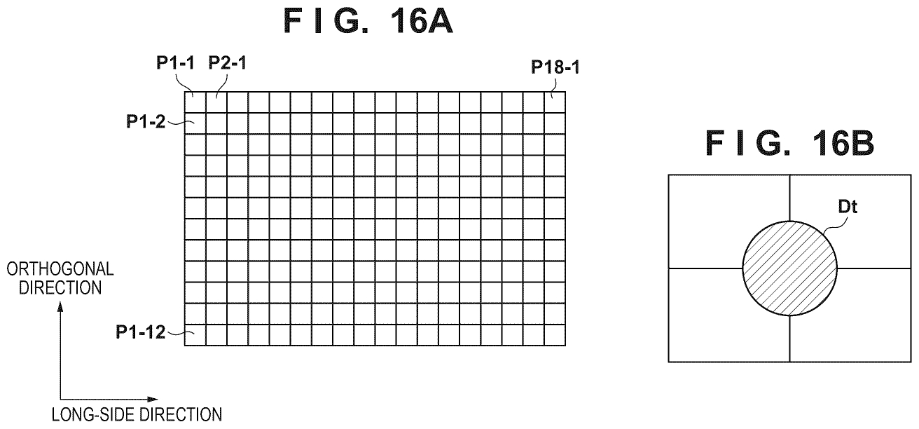

FIG. 16 is a diagram illustrating sample areas for each light-emitting element array chip 400 and influence of a dot. FIG. 16A is a diagram of two-dimensional image information corresponding to one light-emitting element array chip 400 obtained by the scanner unit 100. In the present embodiment, an image region corresponding to one light-emitting element array chip 400 is divided into two directions: the long-side direction of the exposure head 106 and a direction that (here, orthogonally) intersects the long-side direction of the exposure head 106 (hereinafter, an “orthogonal direction”). Accordingly, the image region is divided into two-dimensionally arranged sample areas. Specifically, the image region is divided into 18 sample areas in the long-side direction of the exposure head 106, and divided into 12 sample areas in the orthogonal direction. The orthogonal direction is an example of an intersecting direction. Once the average density of each sample area is detected, the CPU 811 converts the average density into light intensity for the sample area through the density-light intensity conversion processing described above.

By performing the following processing, the CPU 811 calculates light intensity of columns corresponding to 18 sample areas arranged in the long-side direction of the exposure head 106. A sample area column is a column extending in the orthogonal direction. The CPU 811 deletes at least sample areas of the maximum value and the minimum value (here, light intensity values or density values) from the 12 sample areas arranged in the orthogonal direction. In the present embodiment, the CPU 811 deletes the sample areas having the largest and second largest values of light intensity or density and the smallest and second smallest values of light intensity or density, from the 12 sample areas arranged in the orthogonal direction. The CPU 811 calculates, as light intensity of the sample areas in the long-side direction, the average value of light intensity of 18 sample areas arranged in the long-side direction, based on the eight remaining sample areas in the orthogonal direction which were not removed from among the 12 sample areas arranged in the orthogonal direction of the exposure head 106. For example, the CPU 811 performs processing for averaging the data of the 8 sample areas, excluding the two sample areas having the largest and second largest data size and two sample areas having the smallest and second smallest data size, from out of the data of the light intensity of 12 sample areas p1-1 to p1-12, to calculate an average value as light intensity of the sample areas in a sample area column p1. Note that the CPU 811 may first calculate the average density instead of the average light intensity and then calculates light intensity.

FIG. 16B shows a state where a dot Dt is unintentionally printed on the light intensity correction chart due to dirt or the like. In a case where the unnecessary dot Dt is printed on the chart, and a case where an image appears washed out, an error occurs in a result of calculating light intensity. For this reason, as described above, even if the unintended dot Dt is printed, the CPU 811 can suppress the occurrence of error in detection of light intensity by excluding sample areas of the two highest and two lowest values in light intensity (or density), from each sample area column that extends in the orthogonal direction and includes 12 sample areas.

### Step S2204: Method for Calculating Light Intensity Differences Between First Chips and Measures Against Density Variation and Streaks

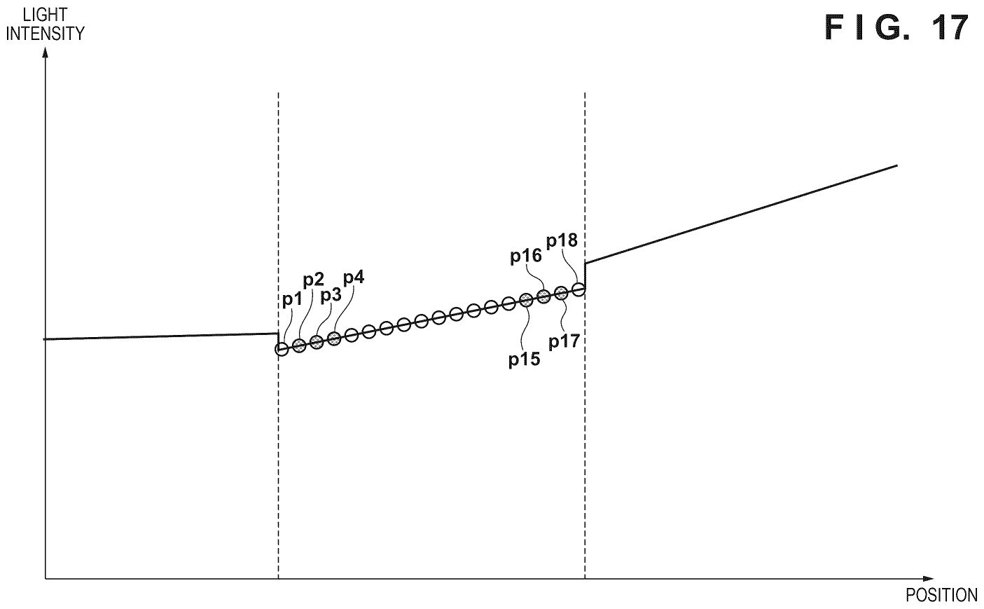

FIG. 17 is a diagram showing light intensity distribution of 18 sample area columns corresponding one light-emitting element array chip 400. A sample area column in this context is a column of sample areas extending in the orthogonal direction. For example, the sample area column p1 is a column of sample areas that include the sample areas p1-1 to p1-12.

The CPU 811 calculates light intensity at the right and left end portions of each light-emitting element array chip 400, for light intensity information of the 18 sample area columns p1 to p18 in the light-emitting element array chip 400 calculated in step S2203. There is the possibility that the light-emitting element array chips 400 adjacent to the sample area columns p1 and p18 at the furthermost end portions detects the density of the image to be printed, and thus the CPU 811 excludes the sample area columns p1 and p18 from the calculation of the light intensity of the sample area columns p1 and p18. In other words, the CPU 811 calculates the light intensity of the sample area columns p1 and p18 at the left and right end portions using the second columns onward, that is, sample area columns p2, p3 . . . and the sample area columns p17, p16. Here, the CPU 811 calculates the light intensity of the sample area columns p1 and p18 at the left and right end portions, using three sample area columns at the left and right end portions, excluding the sample area columns p1 and p18 at the leftmost and rightmost end portions. Specifically, the CPU 811 calculates the light intensity of the sample area column p1 at the left end using three sample area columns p2 to p4 at the left end excluding the sample area column p1 of the light-emitting element array chip 400. The CPU 811 calculates the light intensity of the sample area column p18 at the right end using the data of the sample area columns p15 to p17 at the right end excluding the sample area column p18 of the light-emitting element array chip 400. The CPU 811 may calculate light intensity of sample area columns in the two right and left end portions of the light-emitting element array chip 400 by performing approximate calculation of the three sample area columns using a technique such as the least-squares method as a calculation method. The CPU 811 can obtain light intensity at the left and right end portions with high accuracy, by performing approximation using a linear function or a quadratic function as an approximation formula, even when there are density differences within a light-emitting element array chip 400 due to long-period density variation.

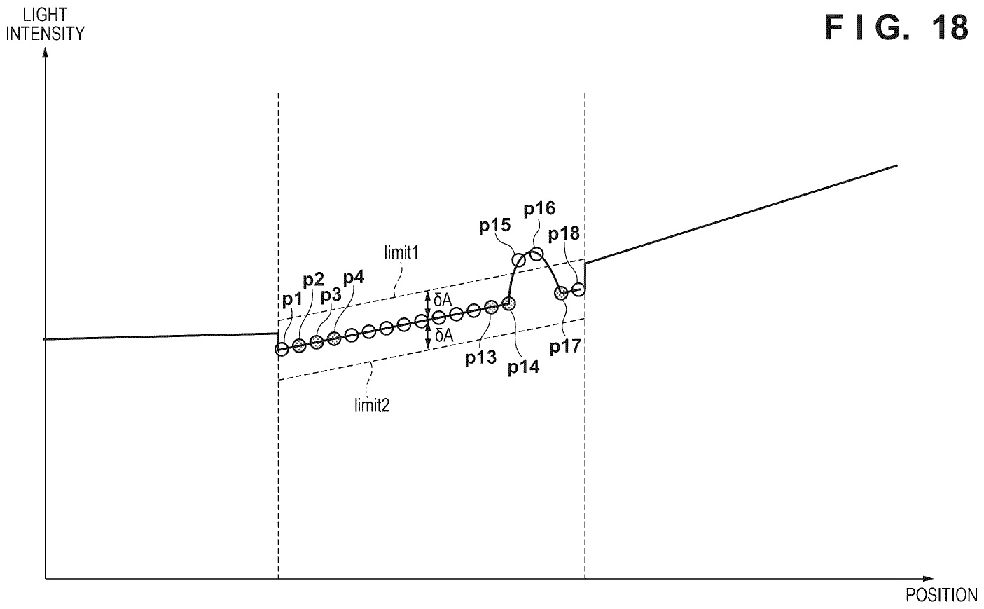

Here, an image printed by the image forming apparatus 10 may include vertical streaks due to various factors within the apparatus. FIG. 18 is a diagram showing light intensity distribution in a case where vertical streaks have occurred in an image. In this example, higher light intensity is obtained from the sample area columns p15 and p16 than nearby sample area columns. If the CPU 811 calculates light intensity at the right end portion of the light-emitting element array chip 400 using the sample area columns p15 and p16, the error in light intensity is large. Therefore, in such a case, the CPU 811 derives an approximation formula from the sample area columns p17, p14, and p13, excluding sample area columns p15 and p16 from the sample area columns of the second column onward from the end portion. The CPU 811 calculates an approximation formula by the least squares method for the light intensity of the sample area columns p2 to p17, as a method of exclusion, and excludes sample area columns whose light intensity are outside a predetermined allowable amount range of ±δA (range between limit 1 and limit 2 in the figure). In addition, the CPU 811 newly sets the same number of sample area columns as the excluded sample area columns, on the central side of the light-emitting element array chip 400 relative to the excluded sample area columns (the sample area columns p13 and p14 in FIG. 18). Therefore, the CPU 811 calculates the light intensity of the sample area column p18 at the end portion (here, the right end portion) by extracting the sample area columns whose light intensity is within the allowable amount range ±δA from the sample area columns of the second sample area column onward from the end portion, in order of the sample area column closest to the end portion.

### Step S2204: Method for Calculating Light Intensity Differences Between Second Chips, Fix Center of Exposure Head, and Adjust Right and Left

In the present embodiment, using the light intensity of the two end portions of each light-emitting element array chip 400 calculated by performing the above-described processing, the CPU 811 determines a drive current value of the light-emitting element array chip 400 so as to decrease light intensity differences between the light-emitting element array chips 400. If drive current adjustment amounts of the light-emitting element array chips 400 are too large, there is the possibility that the density of the entire image varies (too thick, or too thin). In view of this, in order to minimize the drive current adjustment amounts, the CPU 811 determines light intensity correction values of the respective light-emitting element array chips 400 based on chips at the center of the exposure head 106 so as to correct the light intensity difference between the right and left light-emitting chips.

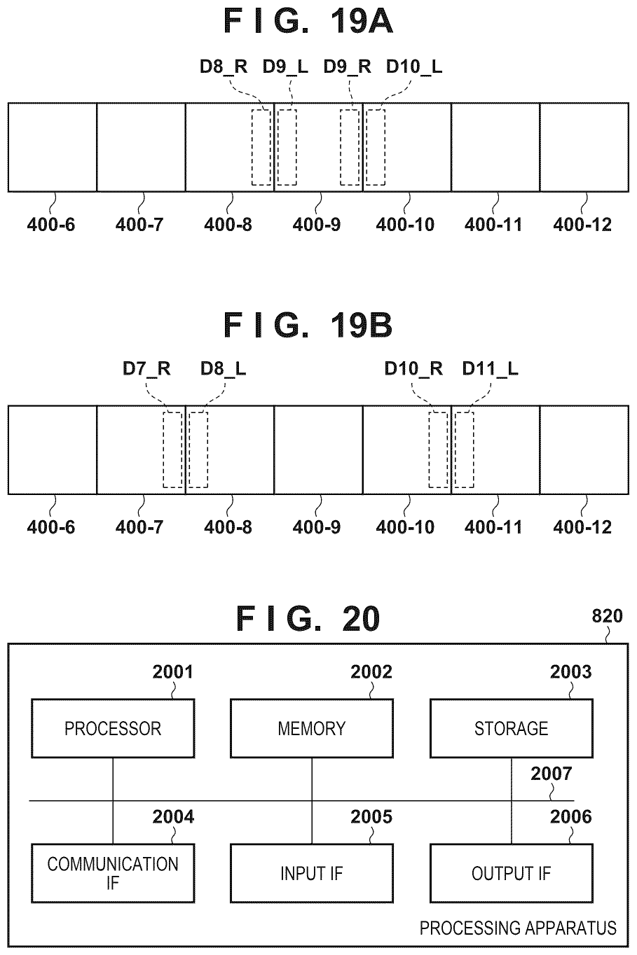

FIGS. 19A and 19B are plan views showing a state where light-emitting element array chips 400 are arranged. Correction of light intensity at boundaries between adjacent light-emitting element array chips 400 will be described with reference to FIGS. 19A and 19B. FIG. 19A shows areas for calculating light intensity of seven light-emitting element array chips 400 at the central portion. First, the CPU 811 derives light intensity of right and left end portions of the light-emitting element array chip 400 at the center, based on light intensity (or density) of an area D9_L and an area D9_R. As a light intensity calculating method, the CPU 811 may obtain light intensity using the above calculation of 18 sample area columns of each light-emitting element array chip 400.

The CPU 811 corrects set light intensity of the light-emitting element array chip 400-8 based on the difference between the light intensity in the area D9_L at the left end portion of the light-emitting element array chip 400-9 and the light intensity in an area D8_R at the right end portion of the light-emitting element array chip 400-8. For example, the CPU 811 may set a value obtained by adding or subtracting the above difference to or from the set light intensity of the light-emitting element array chip 400-8, as set light intensity after correction. Here, conversion between light intensity and a drive current is performed using a predetermined conversion coefficient. As described above, the CPU 811 overwrites a set value of the D/A 901 of the light-emitting element array chip 400-8 with a calculated drive current in order to control the light intensity.

Similarly, the CPU 811 calculates the light intensity of the light-emitting element array chip 400-10 by adding or subtracting the difference between the light intensity of the area D9_R at a right end portion of the light-emitting element array chip 400-9 and the light intensity of an area D10_L at a left end portion of the light-emitting element array chip 400-10, to or from the set light intensity of the light-emitting element array chip 400-10 before correction.

FIG. 19B is a diagram illustrating light intensity of light-emitting element array chips 400 other than the light intensity on the two sides of the light-emitting element array chip 400-9 at the center. Areas D7_R, D8_L, D10_R, and D11_L are areas for calculating light intensity differences for correcting the light intensity of the light-emitting element array chip 400-7 and the light-emitting element array chip 400-11.

Similarly to the light-emitting element array chip 400-8 and the light-emitting element array chip 400-10, the CPU 811 sequentially obtains light intensity based on the difference in light intensity of areas at end portions. The CPU 811 corrects the light intensity of the light-emitting element array chip 400-7 based on the difference in light intensity between the area D7_R and the area D8_L. The CPU 811 corrects the light intensity of the light-emitting element array chip 400-11 based on the difference in light intensity between the area D10_R and the area D11_L. The CPU 811 performs similar processing, sequentially calculates light intensity of light-emitting element array chips 400 along the left-right direction based on the light-emitting element array chip 400-9 at the center of the exposure head 106, and corrects the light intensity of the light-emitting element array chips 400-1 to 400-17.

FIG. 20 is a block diagram showing a hardware configuration of the processing apparatus 820. The processing apparatus 820 is, for example, a computer. The processing apparatus 820 includes a processor 2001, a memory 2002, a storage 2003, a communication IF 2004, an input IF 2005, an output IF 2006, and a bus 2007. The processor 2001, the memory 2002, the storage 2003, the communication IF 2004, the input IF 2005, and the output IF 2006 are connected such that data can be input/output to/from each other via the bus 2007.

The processor 2001 includes the CPU 811. The processing apparatus 820 may include other processors such as a micro processing unit (MPU), a graphics processing unit (GPU), and a quantum processing unit (QPU) in place of or in addition to the CPU 811. The processor 2001 may function as first correction means and second correction means by executing programs.

Some or all of the functions of the image data generation unit 801, the light intensity correction unit 802, the chip data conversion unit 803, and the synchronization signal generation unit 804 may be realized by one or more processors 2001 reading a program stored in the storage 2003, loading the program to the memory 2002, and executing the program, the one or more processors 2001 including the CPU 811.

The memory 2002 is a storage device capable of high-speed reading and writing. The memory 2002 may be, for example, a random-access memory (RAM). The memory 2002 functions as a work area when the processor 2001 executes a program.

The storage 2003 is a nonvolatile large-capacity storage device. The storage 2003 may be, for example, a read only memory (ROM), a hard disk drive (HDD), a solid-state drive (SSD), or the like. The storage 2003 stores a program of correction processing or the like that is executed by the processor 2001, parameters required for executing the program, image data that is a processing target of the program, and the like.

The communication IF 2004 is an interface for connection to an external network. The communication IF 2004 may be a wireless communication interface or a wired communication interface, and is not particularly limited.

The input IF 2005 is an interface that is connected to an input device. The input IF 2005 is connected to input devices such as a user interface, a mouse, a keyboard, a touchpad, and the scanner unit 100. The input IF 2005 outputs a user's instruction and the like input from an input device to the processor 2001.

The output IF 2006 is an interface that is connected to an output device. The output IF 2006 is connected to, for example, an output device such as an image display device including a display. The output IF 2006 outputs data such as image data obtained from the CPU 811 of the processor 2001 or the like to the output device.

As described above, the image forming apparatus 10 according to an embodiment generates correction data for correcting sharp light intensity differences at boundaries between adjacent light-emitting element array chips 400, and corrects light intensity distribution of the exposure head 106 in which the light intensity differences (steps of light intensity) at the boundaries have been corrected using that correction data. Accordingly, in the present embodiment, compared with a case where light intensity distribution of the exposure head 106 is corrected in a state where the sharp light intensity differences at the boundaries remain, it is possible to improve the accuracy of correction, and improve the image quality after correction.

In the present embodiment, in calculation of light intensity of sample area columns, the average value of light intensity of each sample area column excluding at least the largest value and the smallest value of the light intensity of the sample area column is calculated as light intensity of the sample area column. Accordingly, in the present embodiment, it is possible to remove an outlier in light intensity caused by noise or the like, and thus it is possible to improve the accuracy of calculation of light intensity of sample area columns.

In the present embodiment, light intensity of a sample area column at an end portion of a light-emitting element array chip 400 is calculated based on light intensity of the second sample area column onward from the end portion. Accordingly, in the present embodiment, it is possible to improve the accuracy of calculation of light intensity of a sample area column at an end portion that is likely to be affected by an adjacent light-emitting element array chip 400.

In the present embodiment, based on light intensity of sample area columns whose light intensity is within a predetermined allowable amount range from among the second sample area columns onward from an end portion of a light-emitting element array chip 400, the light intensity at the end portion is calculated. Accordingly, in the present embodiment, it is possible to remove an outlier in light intensity caused by noise or the like, and thus it is possible to improve the accuracy of calculation of light intensity of a sample area column at an end portion.

In the present embodiment, in the direction in which a plurality of light-emitting element array chips 400 are arranged, light intensity of the light-emitting element array chips 400 are corrected in order from the center to the end portions. Accordingly, in the present embodiment, compared with a case where the light-emitting element array chips 400 are corrected from an end portion, it is possible to reduce the difference in light intensity before and after correction, and reduce the difference in image before and after correction.

In the present embodiment, a quadratic function for making light intensity distribution for positions in the entire exposure head 106 is generated as correction data, and thus it is possible to reduce the size of correction data.

In the present embodiment, in correction at boundaries and correction of light intensity distribution of the entire exposure head 106, correction data is generated by scanning a light intensity correction chart obtained by printing the same image data. Accordingly, in the present embodiment, it is possible to reduce the size of image data.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-088281, filed May 30, 2024, which is hereby incorporated by reference herein in its entirety.

What is claimed is:

1. An information processing apparatus that generates correction data for correcting light intensity of an image forming apparatus that includes an exposure head that includes a plurality of light-emitting element array chips that each include a plurality of light-emitting elements, the information processing apparatus comprising:
a first correction unit configured to generate first correction data for correcting light intensity differences at boundaries between adjacent light-emitting element array chips; and
a second correction unit configured to generate second correction data for correcting light intensity distribution of the exposure head corrected using the first correction data.

2. The information processing apparatus according to claim 1,
wherein the first correction unit generates the first correction data that decreases light intensity differences at boundaries between adjacent light-emitting element array chips from among the plurality of light-emitting element array chips.

3. The information processing apparatus according to claim 1,
wherein the first correction unit generates the first correction data by calculating the light intensity differences based on data on light intensity obtained by scanning a first image for correction.

4. The information processing apparatus according to claim 1,
wherein the first correction unit calculates light intensity of a plurality of sample areas obtained by two-dimensionally dividing an image region of the plurality of light-emitting element array chips along a plurality of rows extending along a direction in which the plurality of light-emitting element array chips are arranged and a plurality of columns intersecting the rows,
calculates an average value of light intensity excluding at least the largest value and the smallest value of light intensity of each column of sample areas, as light intensity of the column of sample areas, and
calculates the first correction data based on the light intensity.

5. The information processing apparatus according to claim 4,
wherein the first correction unit calculates light intensity of a column that includes a plurality of sample areas at an end portion facing a boundary between light-emitting element array chips, based on light intensity of a column that includes a plurality of sample areas of a second column onward from the end portion.

6. The information processing apparatus according to claim 5,
wherein the first correction unit calculates light intensity of the column of sample areas at the end portion based on light intensity of columns of sample areas whose light intensity is within a predetermined allowable amount range, from among a column in the sample area of the second column onward from the end portion.

7. The information processing apparatus according to claim 1,
wherein the first correction unit corrects light intensity of the light-emitting element array chips from a light-emitting element array chip at a center to light-emitting element array chips at end portions in the direction in which the plurality of light-emitting element array chips are arranged.

8. The information processing apparatus according to claim 1,
wherein the second correction unit generates the second correction data that makes light intensity distribution corresponding to positions of the entire exposure head flatter.

9. The information processing apparatus according to claim 8,
wherein the second correction unit generates, as the second correction data, a quadratic function for making the light intensity distribution flatter.

10. The information processing apparatus according to claim 3,
wherein the second correction unit generates the second correction data based on light intensity obtained by scanning a second image obtained by printing the same image data as the first image based on the first correction data.

11. An image forming apparatus comprising:
the information processing apparatus according to claim 1;
the exposure head that is controlled by the information processing apparatus; and
a photosensitive drum on which an electrostatic latent image is formed by the exposure head.

12. A control method for generating correction data for correcting light intensity of an image forming apparatus that includes an exposure head that includes a plurality of light-emitting element array chips that each include a plurality of light-emitting elements, the method comprising:
generating first correction data for correcting light intensity differences at boundaries between adjacent light-emitting element array chips; and
generating second correction data for correcting light intensity distribution of the exposure head corrected using the first correction data.

13. A non-transitory computer-readable storage medium storing a computer program that, when read and executed by the computer for generating correction data for correcting light intensity of an image forming apparatus that includes an exposure head that includes a plurality of light-emitting element array chips that each include a plurality of light-emitting elements, causes the computer to function as:
a first correction unit configured to generate first correction data for correcting light intensity differences at boundaries between adjacent light-emitting element array chips, and
a second correction unit configured to generate second correction data for correcting light intensity distribution of the exposure head corrected using the first correction data.
